(19) United States
(12) Patent Application Publication
(10) Pub. No.: US 2014/0098810 A1
(43) Pub. Date: Apr. 10, 2014

(54) FABRIC CHIP HAVING A PORT RESOLUTION MODULE

(71) Applicants: Michael G. Frey, Granite Bay, CA (US); Vincent E Cavanna, Loomis, CA (US)

(72) Inventors: Michael G. Frey, Granite Bay, CA (US); Vincent E Cavanna, Loomis, CA (US)

(21) Appl. No.: 14/124,794

(22) PCT Filed: Aug. 8, 2011
(86) PCT No.: PCT/US11/46951

§ 371 Date: Dec. 9, 2013

(51) Int. Cl. H04L 12/18; H04L 12/933

(52) U.S. Cl. CPC H04L 12/1886; H04L 49/101
USPC 370/359

(57) ABSTRACT

A fabric chip includes a plurality of port interfaces, wherein each of the plurality of port interfaces includes a network chip interface (NCI) block having a port resolution module, and wherein the port resolution module is to determine which of the port interfaces is to receive a packet from the NCI block, and a crossbar block communicatively coupled with each of the NCI blocks in the plurality of port interfaces.

### BACKGROUND

Computer performance has increased and continues to increase at a very fast rate. Along with the increased computer performance, the bandwidth capabilities of the networks that connect the computers together have and continue to also increase significantly. Ethernet-based technology is an example of a type of network that has been modified and improved to provide sufficient bandwidth to the networked computers. Ethernet-based technologies typically employ network switches, which are hardware-based devices that control the flow of packets based upon destination address information contained in the packets. In a switched fabric, network switches connect with each other through a fabric, which allows for the building of network switches with scalable port densities. The fabric typically receives data from the network switches and forwards the data to other connected network switches.

In conventional switched fabrics, multicast packets are replicated at the source of the packets and each of the replicated packets are delivered over the fabric to their respective destinations. This causes the fabric near the source of the packets to consume relatively large amounts of bandwidth. In addition, conventional switched fabrics program fixed fabric output ports to move the packets toward destinations, which may lead to inefficient use of and unnecessarily large consumption of the fabric bandwidth. Moreover, when a failure occurs in a connection between the fabric and a network switch, conventional redundant switched fabrics require software interaction to restore traffic flow over the fabric. However, when a failure occurs in a connection between the fabric and a network switch in conventional switched fabrics that are not built with failover capability, data flow across the fabric is halted while software interacts with the fabric to restore traffic flow over the fabric.

### BRIEF DESCRIPTION OF THE DRAWINGS

Features of the present disclosure are illustrated by way of example and not limited in the following figure(s), in which like numerals indicate like elements, in which:

FIG. 1 illustrates a simplified schematic diagram of a network apparatus, according to an example of the present disclosure;

FIG. 2 shows a simplified block diagram of the fabric chip depicted in FIG. 1, according to an example of the present disclosure;

FIGS. 3 and 4, respectively, show simplified block diagrams of switch fabrics, according to two examples of the present disclosure; and

FIGS. 5 and 6, respectively, show flow diagrams of methods for implementing a switch fabric comprising a fabric chip of FIGS. 1-4, according to an example of the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the term “n” following a reference numeral is intended to denote an integer value that is greater than 1. In addition, ellipses (“ . . . ”) in the figures are intended to denote that additional elements may be included between the elements surrounding the ellipses. Moreover, the terms “a” and “an” are intended to denote at least one of a particular element. As used herein, the term “includes” means includes but not limited to, the term “including” means including but not limited to. The term “based on” means based at least in part on.

Disclosed herein is a fabric chip, a switch fabric, and a method for implementing a switch fabric. The fabric chip(s) disclosed herein contains a plurality of port interfaces, in which each of the port interfaces is able to determine which of the other port interfaces is to receive a packet to reach a destination node chip, which may be attached to one of the port interfaces directly or to another fabric chip. In addition, the port interfaces are able to make these determinations independently of software external to the port interfaces. According to an example, a switch fabric implementing the fabric chip(s) disclosed herein have relatively high availability because the fabric chip(s) are able to maintain connectivity between fabric chip(s) in the event of link failures between fabric chips. In addition, the fabric chip(s) disclosed herein enable multicast packets to be communicated to their destination node chips while minimizing fabric congestion by replicating the multicast packets at the farthest point in the switch fabric. As such, the fabric chip(s) disclosed herein enable multicasting of packets without requiring that the source node chip transmit the multicast packet multiple times to the destination node chips.

As used herein, packets may comprise data packets and/or control packets. According to an example, packets comprise data and control mini-packets (MPackets), in which control mpackets are Requests or Replies and data mpackets are Unicast and/or Multicast.

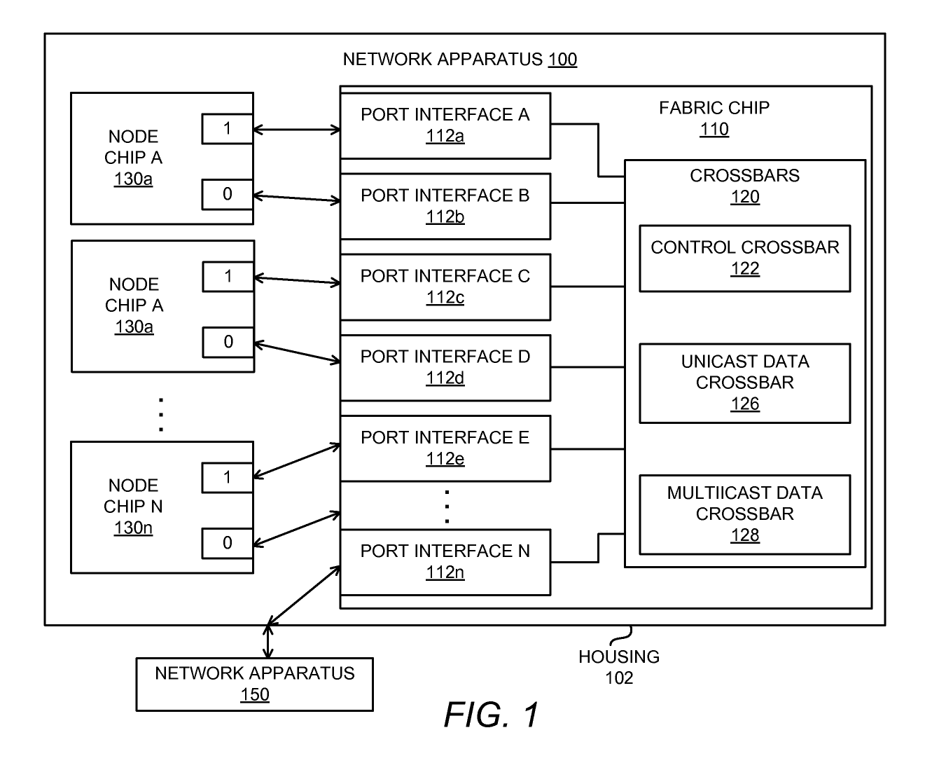

With reference first to FIG. 1, there is shown a simplified diagram of a network apparatus 100, according to an example. It should be readily apparent that the diagram depicted in FIG. 1 represents a generalized illustration and that other components may be added or existing components may be removed, modified or rearranged without departing from a scope of the network apparatus 100.

The network apparatus 100 generally comprises an apparatus for performing networking functions, such as, a network switch, or equivalent apparatus. In this regard, the network apparatus 100 may comprise a housing or enclosure 102 and may be configured for use as a networking component. In other words, for instance, the housing 102 may be configured for placement in an electronics rack or other networking environment, such as in a stacked configuration with other network apparatuses. In other examples, the network apparatus 100 may be inside of a larger ASIC or group of ASICS within a housing. In addition, or alternatively, the network apparatus 100 may provide a part of a fabric network inside of a single housing.

The network apparatus 100 is depicted as including a fabric chip 110 and a plurality of node chips 130a-130n having ports labeled “0” and “1”. The fabric chip 110 is also depicted as including a plurality of port interfaces 112a-112n, which are communicatively coupled to respective ones of the ports “0” and “1” of the node chips 130a-130n. The port interfaces 112a-112n are also communicatively connected to a crossbar array 120, which depicted as including a control crossbar 122, a unicast data crossbar 124, and a multicast data crossbar 126. The port interface 112n is also depicted as being connected to another network apparatus 150, which may include the same or similar configuration as the network apparatus 100. Thus, for instance, the another network apparatus 150 may include a plurality of node chips 130a-130n communicatively coupled to a fabric chip 110. In addition, the fabric chip 110 of the network apparatus 100 may be connected to the fabric chip 110 of the another network apparatus 150 through respective port interfaces 112a, in various manners as discussed in greater detail herein below.

According to an example, the node chips 130a-130n comprise application specific integrated circuits (ASICs) that enable user-ports and the fabric chip 110 to interface each other. Although not shown, each of the node chips 130a-130n may also include a user-port through which data, such as, packets, may be inputted to and/or outputted from the node chips 130a-130n. In addition, each of the port interfaces 112a-112n may include a port through which a connection between a port in the node chip 130a and the port interface 112a may be established. The connections between the ports of the node chip 130a and the ports of the port interfaces 112a-112n may comprise any suitable connection to enable relatively high speed communication of data, such as, optical fibers or equivalents thereof.

According to an example, the fabric chip 110 comprises an ASIC that communicatively connects the node chips 130a-130n to each other. The fabric chip 110 may also comprise an ASIC that communicatively connects the fabric chip 110 to the fabric chip 110 of another network apparatus 150, in which, such connected fabric chips 110 may be construed as back-plane stackable fabric chips. The ports of the port interfaces 112a-112n that are communicatively coupled to the ports of the node chips 130a-130n are described herein as “down-link ports”. In addition, the ports of the port interfaces 112a-112n that are communicatively coupled to the port interfaces 112a-112n of the fabric chip 110 in another network apparatus 150 are described herein as “up-link ports”.

According to an example, packets enter the fabric chip 110 through a down-link port of a source node chip, which may comprise the same node chip as the destination node chip. The destination node chip may be any fabric chip port in the switch fabric, including the one to which the source node chip is attached. In addition, the packets include an identification of which node chip(s), such as a “data-list” a destination bitmask, etc., to which the packets are to be delivered by the fabric chip 110. The up-link ports whose list of node chips 130a-130n matches one or more in the identification of node chip(s) are considered to be “preferred up-link ports”, which will receive the data to be transmitted, unless the “preferred up-link ports” are dead or is otherwise unavailable. If a preferred up-link port is dead or otherwise unavailable, then the port interface 112a that received the data may use a programmable, prioritized list of ports to be used as alternative up-links to select an alternate up-link port to receive the packet instead of the preferred up-link port. The preferred up-link ports may change from stage to stage of the port calculations. In this regard, the identified up-link ports may be considered as the preferred up-link ports during a first stage of the port resolution calculation.

The down-link ports whose list of a single node chip 130a-130n matches one of the node chips in the identification of node chip(s) are considered to be the “active down-link ports”. A “path index” may be embedded in the packet, which selects which of the “active down-link ports” will be used for the packet. This path-based filtering enables the fabric chip 110 to have multiple connections to a node chip 130a.

In any regard, the fabric chip 110 delivers the packets to the node chips 130a-130n in the identification of node chip(s) and are communicatively coupled to the fabric chip 110. However, for the node chips 130a-130n in the identification of node chip(s) that are not communicatively coupled to the fabric chip 110, the fabric chip 110 performs hardware calculations to determine which up-link port(s) the packets will traverse in order to reach those destination node chips. These hardware calculations are defined as “port resolution calculations”.

The port interface 112a transfers the data over the appropriate crossbar 122-126 to one or more other port interfaces 112b-112n and includes a small data word that facilitates the output port calculation that prunes the identification of node chip(s) so that only destination node chips which were supposed to traverse the port are still included in the identification of node chip(s).

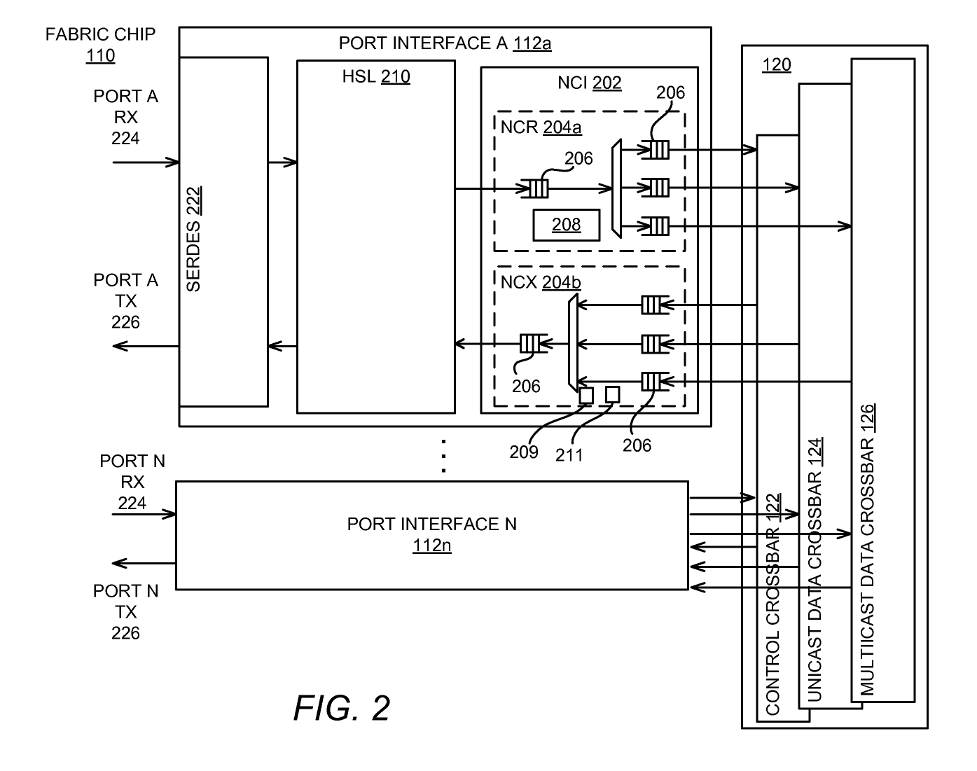

With particular reference now to FIG. 2, there is shown a simplified block diagram of the fabric chip 110 depicted in FIG. 1, according to an example. It should be apparent that the fabric chip 110 depicted in FIG. 2 represents a generalized illustration and that other components may be added or existing components may be removed, modified or rearranged without departing from a scope of the fabric chip 110.

The fabric chip 110 is depicted as including the plurality of port interfaces 112a-112n and the crossbar array 120. The components of a particular port interface 112a are depicted in detail herein, but it should be understood that the remaining port interfaces 112b-112n may include the same or similar components and configurations.

As shown in FIG. 2, the fabric chip 110 includes a network chip interface (NCI) block 202, a high-speed link (HSL) (interface) block 210, and a serializer/deserializer (SerDes) 222. By way of particular example, the SerDes 222 includes a set of eight (8) serdes' running in 8b/10b mode, using a 10:1 frequency ratio. In addition, the SerDes 222 is depicted as interfacing a receipt port 224 and a transmission port 226. Alternatively, however, components other than the HSL block 210 and the serdes 222 may be employed in the fabric chip 110 without departing from a scope of the fabric chip 110 disclosed herein.

The NCI block 202 is depicted as including a network chip receiver (NCR) block 204a and a network chip transmitter (NCX) block 204b. The NCR block 204a feeds data received through the HSL block 210 to the crossbar array 120 and the NCX block 204b transfers data received from the crossbar array 120 to the HSL block 210. The NCR block 204a and the NCX block 204b are further depicted as comprising registers 206, in which some of the registers are communicatively coupled to one of the crossbars 122-126 and others of the registers 206 are communicatively coupled to the HSL block 210.

The NCI block 202 generally transfers data and control mini-packets (MPackets) in full duplex fashion between the corresponding HSL block 210 and the crossbar array 120. In addition, the NCI 202 provides buffering in both directions. The NCI block 202 also includes a port resolution module 208 that interprets destination and path information contained in each received MPacket. The port resolution module 208 uses the interpreted destination and path information to index into a look-up table that determines the correct destination NCI block 202 in a different port interface 112b-112n of the fabric chip 110, to make the next hop to the correct destination node chip 130a-130n, which may be attached to a down-link port or an up-link port of the fabric chip 110. In this regard, the port resolution module 208 may determine which ports (up-links and/or down-links) the packet is to be outputted through based upon the information contained in the received MPackets. In addition, the port resolution module 208 interprets the destination and path information, determines the correct NCI block 202, and determines the ports to which the packet is to be outputted independently of external software. In other words, the port resolution module 208 need not be controlled by external software to perform these functions.

The NCX block 204b also includes a node pruning module 209 and unicast conversion module 211 that operates on packets received from the multicast data crossbar 126. More particularly, the unicast conversion module 211 is to process the packets to identify a data word in the data that facilitates the output port calculation. In addition, the node pruning module 209 is to prune the data-list such that only destination node chips 130a-130n that were supposed to traverse the port are still included in the data-list. Thus, for instance, if the NCX block 204b receives a multi-cast packet listing a chip node 130a of the fabric chip 110 and a chip node 130 attached to another network apparatus 150, the NCX block 204b may prune the identification of the node chip(s) of the multi-cast packet to remove the chip node 130a of the fabric chip 110 prior to the multi-cast packet being sent out to the another apparatus 150.

The HSL block 210 generally operates to initialize and detect errors on the hi-speed links, and, if necessary, to re-transmit data. According to an example, the data path between the NCI block 202 and the HSL block 210 is 64 bits wide in each direction.

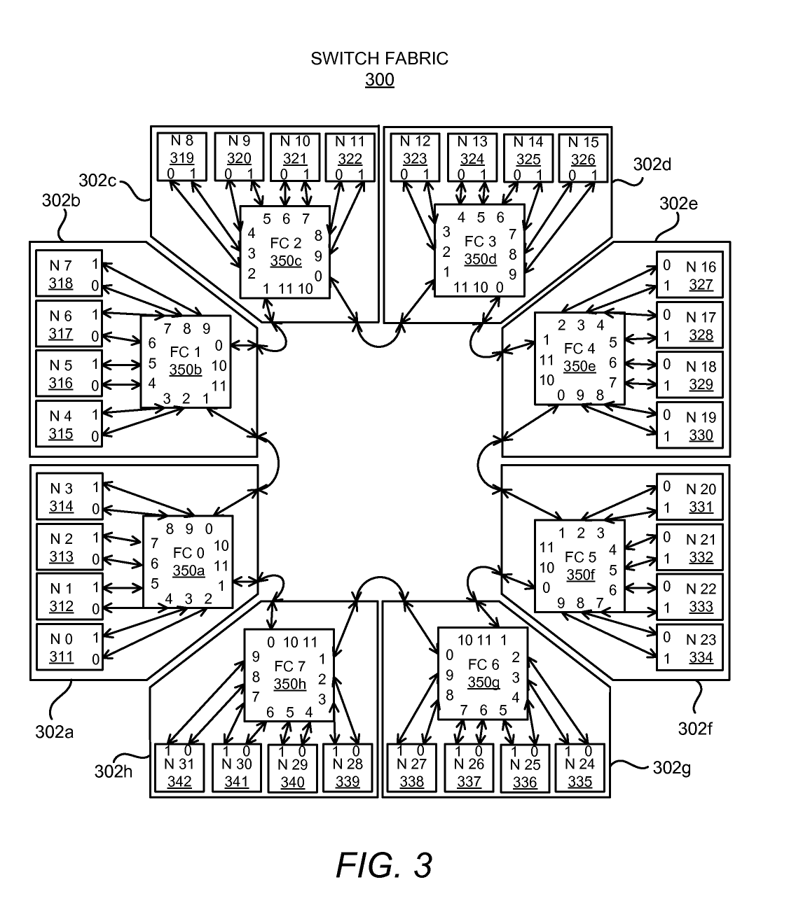

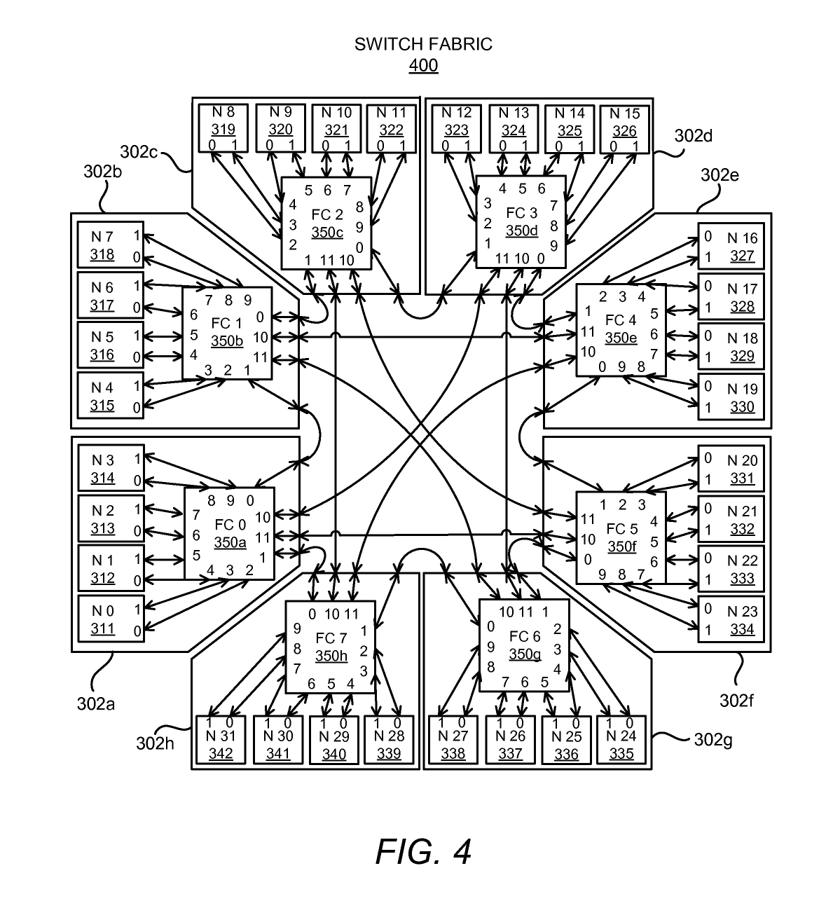

Turning now to FIGS. 3 and 4, there are respectively shown simplified block diagrams of switch fabrics 300 and 400, according to two examples. It should be apparent that the switch fabrics 300 and 400 depicted in FIGS. 3 and 4 represent generalized illustrations and that other components may be added or existing components may be removed, modified or rearranged without departing from the scopes of the switch fabrics 300 and 400.

The switch fabrics 300 and 400 are depicted as including a plurality of network apparatuses 302a-302h. Each of the network apparatuses 302a-302h is also depicted as including a respective fabric chip (FC0-FC7) 350a-350h. Each of the network apparatuses 302a-302h may comprise the same or similar configuration as the network apparatus 100 depicted in FIG. 1. In addition, each of the fabric chips 350a-350h may comprise the same or similar configuration as the fabric chip 110 depicted in FIG. 2.

In any regard, as shown in the switch fabrics 300 and 400, the network apparatuses 302a-302h are each depicted as including four node chips (N0-N31) 311-342. Each of the node chips (N0-N31) 311-342 is depicted as including two ports (0, 1), which are communicatively coupled to a port (0-11) of at least one respective fabric chip 350a-350h. More particularly, each of the ports of the node chips 311-342 is depicted as being connected to one of twelve ports 0-11. In addition, the node chips 311-342 are depicted as being connected to respective fabric chips 350a-350h through bi-directional links. In this regard, data may flow in either direction between the node chips 311-342 and their respective fabric chips 350a-350h.

As discussed above with respect to FIG. 1, the ports of the fabric chips 350a-350h that are connected to the node chips 311-342 are termed “down-link ports” and the ports of the fabric chips 350a-350h that are connected to other fabric chips 350a-350h are termed “up-link ports”. Each of the up-link ports and the down-link ports of the fabric chips 350a-350h includes an identification of destination node chip(s) 311-342 that should be reached through that link. In addition, the data supplied into the switch fabrics 300 and 400 includes with it an identification of the node chip(s) 311-342 to which the packet is to be delivered. The up-link ports whose identification of node chip(s) 311-342 matches one or more node chips in the identification of the node chip(s), or chip mask, is considered to be a “preferred up-link port”, which will receive the data to be transmitted, unless the “preferred up-link port” is dead or is otherwise unavailable. If a preferred up-link is dead or otherwise unavailable, then the port resolution module 208 may use a programmable, prioritized list of ports to be used as alternative up-link ports to select an alternate up-link port to receive the packet instead of the preferred up-link port.

The down-link ports whose list of a single node chip 130a-130n matches one of the node chips in the identification of node chip(s) are considered to be the “active down-link ports”. A “path index” may be embedded in the packet, which selects which of the “active down-link ports” will be used for the packet. This path-based filtering enables a fabric chip 350a-350h to have multiple connections to a node chip 311-342.

In any regard, the fabric chips 350a-350h are to deliver the packet to the node chips 311-342 that are in the identification of the node chip(s). For those node chips 311-342 contained in the identification of the node chip(s) that are connected to down-link ports of a fabric chip 350a, the fabric chip 350a may deliver the data directly to those node chips 311-314. However, for the node chips 315-342 contained in the identification of node chip(s) that are not connected to down-link ports of the fabric chip 350a, the fabric chip 350a performs hardware calculations to determine which up-link port(s) the data will traverse in order to reach those node chips 315-342. These hardware calculations are defined as “port resolution” or “port resolution calculations”.

The switch fabric 300 depicted in FIG. 3 comprises a ring network configuration, in which each of the fabric chips 350a-350h is connected to exactly two other fabric chips 350a-350h. More particularly, ports (0) and (1) of adjacent fabric chips 350a-350h are depicted as being communicatively connected to each other. As such, a single continuous pathway for data signals to flow through each node is provided between the network apparatuses 302a-302h.

The switch fabric 400 depicted in FIG. 4 comprises a mesh network configuration, in which each of the fabric chips 350a-350h captures and disseminates packets received from their respective node chips 311-342 and operates as a relay for other fabric chips 350a-350h. The mesh network configuration of the switch fabric 400 provides greater bandwidth, resiliency, and fewer hops (latency) as compared with the ring network configuration of the switch fabric 300. In addition, packets may be communicated between the nodes 311-342 in any of the manners discussed with respect to the switch fabric 300.

Although the switch fabrics 300 and 400 have been depicted as including eight network apparatuses 302a-302h, with each of the network apparatuses 302a-302h including four node chips 311-342 each, it should be clearly understood that the switch fabrics 300 and 400 may include any reasonable number of network apparatuses 302a-302h without departing from the scopes of the switch fabrics 300 and 400. In addition, the network apparatuses 302a-302h may each include any reasonably suitable number of node chips 311-342 without departing from the scopes of the switch fabrics 300 and 400. Furthermore, each of the fabric chips 350a-350h may include any reasonably suitable number of port interfaces 112a-112n and ports.

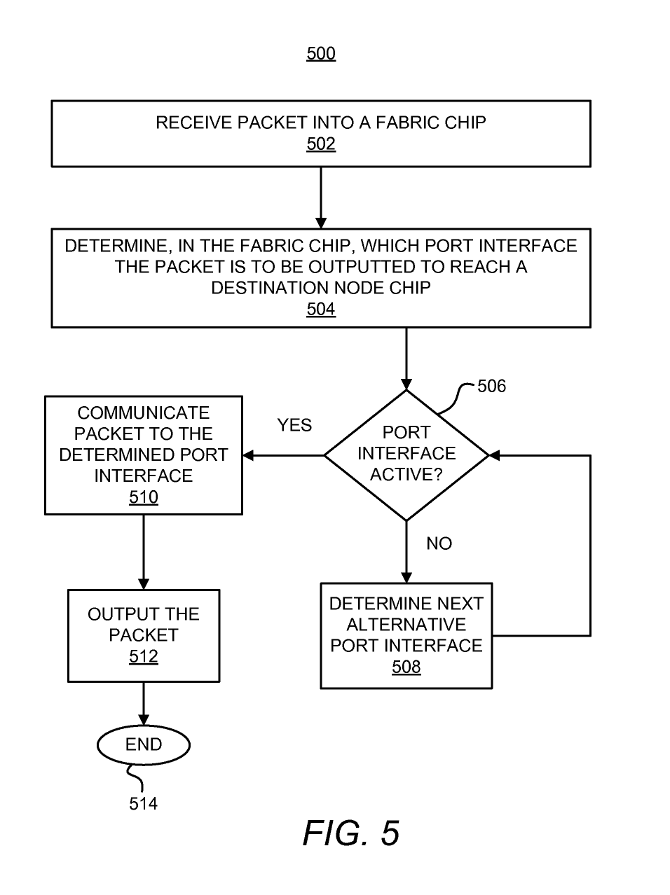

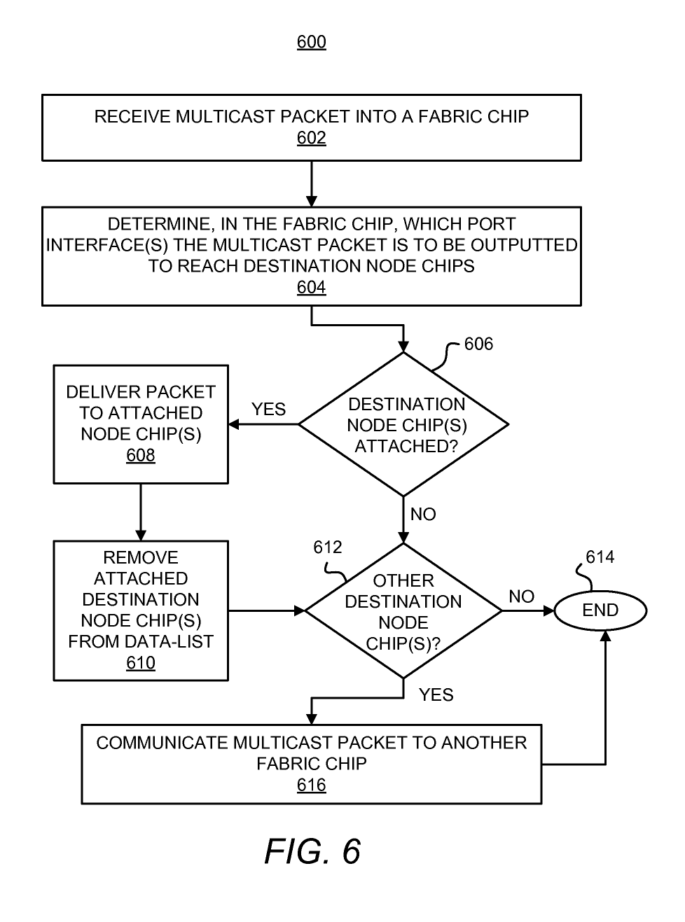

Various manners in which the switch fabrics 300 and 400 may be implemented are described in greater detail with respect to FIGS. 5 and 6, which, respectively depict flow diagrams of methods 500 and 600 for implementing a switch fabric comprising a fabric chip 110, 350a of FIGS. 1-4, according to an example. It should be apparent that the methods 500 and 600 represent generalized illustrations and that other steps may be added or existing steps may be removed, modified or rearranged without departing from the scopes of the methods 500 and 600.

The descriptions of the methods 500 and 600 are made with particular reference to the fabric chips 110 and 350a-350h depicted in FIGS. 1-4. It should, however, be understood that the methods 500 and 600 may be implemented in fabric chip(s) that differ from the fabric chips 110 and 350a without departing from the scopes of the methods 500 and 600. In addition, although reference is made to particular ones of the network apparatuses 302a-302h, and therefore particular ones of the fabric chips 350a-350h and the node chips 311-342, it should be understood that the operations described herein may be performed by and in any of the network apparatuses 302a-302h.

Each of the port interfaces 112a-112n of the fabric chips 110, 350a-350h may be programmed with the destination node chips 130a-130n, 311-342 that are to be reached through the respective port interfaces 112a-112n. Thus, for instance, the port interface 112a containing the port 2) of the fabric chip (FC0) 350a may be programmed with the node chip (N0) 311 as a reachable destination node chip for that port interface 112a. As another example, the port interface 112n containing the port (0) of the fabric chip (FC0) 350a may be programmed with the node chips (N4-N31) 315-342 or a subset of these node chips as the reachable destination node chips for that port interface 112n.

In addition, each of the port interfaces 112a-112n of the fabric chips 110, 350a-350h may be programmed with respective prioritized lists of ports to be used as up-link ports. Each of the respective prioritized lists of ports includes a preferred up-link port and ordered alternative ports.

Generally speaking, the method 500 depicted in FIG. 5 pertains to various operations performed by a fabric chip 350a-350h in response to receipt of a unicast packet. In addition, the method 600 depicted in FIG. 6 pertains to various operations performed by a fabric chip 350a-350h in response to receipt of a multicast packet. In both methods 500 and 600, the packet may include various information, such as, an identification of the node chip(s) to which the packet is to be delivered, such as, a “data-list”, a bitmask, etc. A “path index” may also be embedded in the packet, which selects which of a plurality of active down-link ports are to be used to deliver the packet to the destination node chip(s) contained in the data-list.

With reference first to FIG. 5, at block 502, a packet is received into a fabric chip 350a. The fabric chip 350a may receive the packet through a down-link port from one of the attached node chips 311-314 or through an up-link port from another fabric chip 350b-350h. In either event, and as depicted in FIG. 2, the packet may be received through the receipt port 224, into the serdes 222, the HSL 210, and into a register 206 of the NCR 204a.

At block 504, a determination, in the fabric chip 350a, of which port interface 112b-112n of the fabric chip 350a the packet is to be outputted to reach a destination node chip(s) listed in the data-list is made, for instance, by the port resolution module 208 of the port interface 112a. In instances where the destination node chip(s) is connected to a down-link port of the fabric chip 350a, the port resolution module 208 may identify the port interface 112b-112n containing the down-link port(s) to the destination node chip(s) from the programmed list of node chips that are reachable through the port interfaces 112a-112n of the fabric chip 350a at block 504. In the examples depicted in FIGS. 3 and 4, the port resolution module 208 may determine that the packet is to be outputted through one of ports (2)-(9).

In instances where the destination node chip(s) is not connected to a down-link port of fabric chip 350a, the port resolution module 208 may identify the port interface 112b-112n containing the up-link port(s) to another fabric chip 350b-350h that is in direct communication with the destination node chip (s). In the examples depicted in FIGS. 3 and 4, the port resolution module 208 may determine that the packet is to be outputted through one of ports (0) and (1). In addition, the port resolution module 208 may select the port interface 112b-112n to receive the packet from the prioritized lists of ports, which may include a preferred up-link port and ordered alternative ports. As such, at block 504, the port resolution module 208 may select the preferred up-link to receive the packet.

At block 506, a determination as to whether the determined port interface 112b-112n is active is made, for instance, by the port resolution module 208. That is, for instance, the port resolution module 208 may determine whether the determined port interface 112b-112n is dead or is otherwise unavailable. The port resolution module 208 may make this determination based upon a prior identification that communication of a packet was not delivered through that port interface 112b-112n. The port resolution module 208 may also make this determination by determining that an attempt to communicate the packet to that port interface 112b-112n has failed.

In response to a determination that the determined port interface 112b-112n is inactive at block 506, a next alternative port interface 112b-112n is determined at block 508, for instance, by the port resolution module 208. The port resolution module 208 may determine the next alternative port interface 112b-112n from the prioritized lists of ports to be used as up-link ports to reach the destination chip node(s) 311-342. That is, the port resolution module 208 may select the next port interface 112b-112n in the prioritized list to receive the packet. The port resolution module 208 may also determine whether the selected port interface is active at block 506, and may determine and select the next port interface 112b-112n in the prioritized list at block 508 in response to a determination that the selected port interface is inactive. Blocks 506 and 508 may be repeated until an active port interface 112b-112n is determined.

At block 510, the packet is communicated to the determined port interface 112b-112n. More particularly, for instance, the NCR 204a of the port interface 112a containing the packet may communicate the packet to the determined port interface 112b-112n through the unicast data crossbar 124. In addition, the determined port interface 112b-112n may receive the packet from the unicast data crossbar 124 through the NCX 204b.

At block 512, the determined port interface 112b-112n outputs the packet. In instances where the destination node chip(s) 311-342 is connected to the determined port interface 112b-112n through a down-link port, the packet is delivered directly to the attached node chip(s) 311-342. In instances where the destination node chip(s) 311-342 is not directly connected to the determined port interface 112b-112n, the packet is delivered to another fabric chip 350b-350h.

At block 514, the method 500 may end for the fabric chip 350a. In addition, the fabric chip(s) 350b-350h that receives the packet from the fabric chip 350a may implement blocks 502-512 as necessary.

By way of particular example in which a packet is to be communicated from node chip (N4) 315 to node chip (N15) 326, the node chip (N4) 315 communicates the packet to either port (2) or (3) of the fabric chip (FC1) 350b. As discussed above with respect to FIG. 1, the packet from the node chip 315 contains a list of the node chip(s) to which the packet is to be delivered (data-list). In this case, the list includes just the node chip (N15) 326. In addition, the port resolution module 208 of the NCR 204a of the port interface 112a through which the packet was received from the node chip 315 performs a calculation, in hardware, to determine which up-link port(s) of the port interface 112a that packet will traverse to reach the destination node chip 326. More particularly, for instance, the packet may include mini-packets (MPackets) that include destination and path information, which the port resolution module 208 may interpret. As discussed above, the packet may comprise a control packet and/or a data packet. A control packet comprises at least one MPacket, whereas, a data packet comprises two or more MPackets.

In any regard, the port resolution module 208 may use this information to index into a look-up table that determines the correct NCI block 202 of the fabric chip 350b to make the next hop to the destination node chip 326. In the above example, the port resolution module 208 may determine that the NCI block 202 of the up-link port (0) is the correct NCI block 202. As such, the NCR 204a of the port interface 112a may communicate the packet to the NCI block 202 of the port interface 112n containing the up-link port (0). The port interface 112n containing the up-link port (0) may communicate the packet to the fabric chip (FC2) 350c connected to up-link port (0).

The fabric chip (FC2) 350c may receive the packet through up-link port (0) and the NCR 204a of the port interface 112a containing that up-link port (0) may use the information contained in the packet to determine the correct NCI block 202 of the fabric chip 350c the packet is to be delivered to make the next hop to the destination node chip 326. In this example, the port resolution module 208 may determine that the NCI block 202 of the up-link port (0) is the correct NCI block 202. In addition, the NCR 204a of the port interface 112n containing the up-link port (0) may receive the packet from the port interface 112a containing the up-link port (1) and may communicate the packet to fabric chip (FC3) 350d.

The fabric chip (FC3) 350d may receive the packet through up-link port (1) and the NCR 204a of the port interface 112a containing the up-link port (1) may use the information contained in the packet to determine the correct NCI block of the fabric chip 350d the packet is to be delivered to make the next hop to the destination node 326. In this example, the port resolution module 208 of the NCR 204a of the port interface 112a may determine that the NCI block of the down-link port (8) is the correct NCI block 202. In addition, the NCR 204a of the port interface 112n containing the down-link port (8) may receive the packet from the port interface 112a containing the up-link port (0) and may communicate the packet to the node chip 326, thus completing delivery of the packet to the destination node chip 326.

In the event that the preferred up-link port (1) in the fabric chip (FC2) 350c is dead or is otherwise unavailable, the fabric chip 350b may determine that the packet was not received by the fabric chip 350c and may determine an alternative up-link to receive the packet. In the example above, the port resolution module 208 may determine that the up-link port (1) in the fabric chip 350b is an appropriate alternative up-link to receive the packet. In addition, the fabric chip 350b may communicate the packet to the fabric chip (FC0) 350a, which may communicate the packet to the fabric chip (FC7) 350h, and so forth, until the packet reaches the fabric chip (FC3) and onto the destination node chip 326 as discussed above. According to an example, each of the port resolution modules 208 in the fabric chips 350a-350c is programmed with a ordered list of up-links to which packet is to be communicated. In this example, the appropriate alternative up-link comprises the next up-link in the ordered list of up-links.

With reference now to FIG. 6, at block 602, a multicast packet is received into a fabric chip 350a. The fabric chip 350a may receive the multicast packet through a down-link port from one of the attached node chips 311-314 or through an up-link port from another fabric chip 350b-350h. In either event, and as depicted in FIG. 2, the packet may be received through the receipt port 224, into the serdes 222, the HSL 210, and into a register 206 of the NCR 204a.

At block 604, a determination, in the fabric chip 350a, of which port interface(s) 112b-112n of the fabric chip 350a the multicast packet is to be outputted to reach destination node chips in the identification of node chip(s) is made, for instance, by the port resolution module 208 of the port interface 112a.

At block 606, a determination as to whether any of the destination nodes 311-342 is attached to down-link ports of the fabric chip 350a is made, for instance, by the port resolution module 208 of the fabric chip 350a. In response to a determination that a destination node is attached to a down-link port of the fabric chip 350a at block 606, the port resolution module 208 may identify the port interface 112b-112n containing the down-link port(s) to the destination node chip(s) from the programmed list of node chips that are reachable through the port interfaces 112a-112n of the fabric chip 350a. In addition, the NCR 204a of the port interface 112a may deliver the multicast packet to the port interface 112b-112n containing the determined down-link port at block 608, for instance, over the multicast data crossbar 126. In addition, at block 610, the attached destination node chip(s) 311-342 to which the packet has been delivered may be removed from the identification of node chip(s).

Following block 608 and/or in response to the “no” condition at block 606, a determination as to whether the identification of node chip(s) contains other destination node chips 311-342 is made at block 612, for instance, by the port resolution module 208. In response to a determination that all of the destination node chips 311-342 are attached to down-links of the fabric chip 350a and thus that there are no other destination node chips in the identification of node chip(s), the method 600 may end as indicated at block 614.

However, in response to a determination that the identification of node chip(s) contains other destination node chip(s) 311-342, the multicast packet is communicated to another fabric chip 350b-350h, as indicated at block 616. More particularly, for instance, the port resolution module 208 may select the port interface 112b-112n to receive the multicast packet from the prioritized lists of ports, which includes a preferred up-link port and ordered alternative ports. As such, at block 616, the port resolution module 208 may select the preferred up-link port to receive the multicast packet and may communicate the multicast packet to the port interface 112b-112n containing the selected up-link port. In addition, the port resolution module 208 may implement blocks 506-512 in FIG. 5 in determining and communicating the multicast packet to an active port interface 112b-112n. Moreover, for instance, the NCR 204a of the port interface 112a may deliver the multicast packet to the port interface 112b-112n containing the determined up-link port at block 616, for instance, over the multicast data crossbar 126.

The method 600 may end following communication of the multicast packet to the another fabric chip 350b-350h. In addition, the fabric chip(s) 350b-350h that receive the multicast packet from the fabric chip 350a may implement blocks 602-616 to deliver the multicast packet to the destination node chips 311-342.

By way of particular example in which the multicast packet is to be communicated from node chip (N1) 312 to node chips (N4 and N9) 315 and 320, the node chip (N1) 312 communicates the packet to either port (4) or (5) of the fabric chip (FC0) 350a. In this example, the data-list includes the node chips (N4 and 29) 315 and 320. In addition, the port resolution module 208 of the NCR 204a of the port interface 112a through which the packet was received from the node chip 312 performs a calculation, in hardware, to determine which up-link port(s) of the port interface 112a that packet will traverse to reach the destination node chips 315 and 320. More particularly, for instance, the port resolution module 208 may interpret the destination and path information contained in mini-packets (MPackets) of the packet. In addition, the port resolution module 208 may use this information to index into a look-up table that determines the correct NCI block 202 of the fabric chip 350a to make the next hop to the destination node chips 315 and 320. In the instant example, the port resolution module 208 may determine that the NCI block 202 of the up-link port (0) is the correct NCI block 202. As such, the NCR 204a of the port interface 112a may communicate the packet to the NCI block 202 of the port interface 112n containing the up-link port (0). The port interface 112n containing the up-link port (0) may communicate the packet to the fabric chip (FC1) 350b connected to up-link port (0).

The fabric chip (FC1) 350b may receive the packet through up-link port (1) and the NCX 204b of the port interface 112a containing the up-link port (1) may use the information contained in the packet to determine whether the packet is to be delivered to any of the chip nodes (N4-N7) 315-318 of the network apparatus 302b. Since the packet is to be delivered to the chip node 315, the NCR 204a may deliver the packet to the port interface 112b containing the down-link port (2) to the chip node 315 and the NCX 204b may remove the chip node 315 from the identification of node chip(s) that are to receive the packet. In addition, the port resolution module 208 of the NCR 204a of the port interface 112a may determine that the NCI block 202 of the up-link port (0) is the correct NCI block 202 to make the next hop to the node chip 320 contained in the identification of node chip(s) that are to receive the packet. Moreover, the NCR 204a of the port interface 112n containing the up-link port (0) may receive the packet from the port interface 112a containing the up-link port (1) and may communicate the packet to fabric chip (FC2) 350c.

The fabric chip (FC2) 350c may receive the packet through up-link port (1) and the NCR 204a of the port interface 112a containing the up-link port (1) may use the information contained in the packet to determine the correct NCI block 202 of the fabric chip 350c the packet is to be delivered to make the next hop to the destination node 320. In this example, the port resolution module 208 of the NCR 204a of the port interface 112a may determine that the NCI block of the down-link port (4) is the correct NCI block 202. In addition, the NCR 204a of the port interface 112n containing the down-link port (4) may receive the packet from the port interface 112a containing the up-link port (0) and may communicate the packet to the node chip 320, thus completing delivery of the packet to the destination node chip 320.

In one regard, because the fabric chips 350a-350h control delivery and forwarding of the packets to the node chips 311-342, the multi-cast packet need be sent by a node chip 311 once, instead of individually to each of the destination nodes. This reduces the amount of bandwidth consumed in the switch fabric 300, 400 in delivering the packet to the intended node chips 311-342.

What has been described and illustrated herein are various examples of the present disclosure along with some of their variations. The terms, descriptions and figures used herein are set forth by way of illustration only and are not meant as limitations. Many variations are possible within the spirit and scope of the present disclosure, in which the present disclosure is intended to be defined by the following claims—and their equivalents—in which all terms are mean in their broadest reasonable sense unless otherwise indicated.

What is claimed is:

1. A fabric chip comprising:
a plurality of port interfaces, wherein each of the plurality of port interfaces includes a network chip interface (NCI) block having a port resolution module, and wherein the port resolution module is to determine which of the port interfaces is to receive a packet from the NCI block; and
a crossbar block communicatively coupled with each of the NCI blocks in the plurality of port interfaces.

2. The fabric chip according to claim 1, wherein the packet contains an identification of at least one destination node chip that is to receive the packet, and wherein the port resolution module is to determine which of at least one of the port interfaces is to receive the packet based upon a comparison of the node chips contained in the identification and a preprogrammed correlation between the interface ports and the destination node chips.

3. The fabric chip according to claim 2, wherein the NCI block is composed of a network chip receiving (NCR) block and a network chip transmitting (NCX) block, and wherein the NCR block contains the port resolution module.

4. The fabric chip according to claim 2, wherein the NCX block comprises a node pruning module to prune the identification by removing a destination node chip from the identification to which a multicast packet has been delivered prior to the multicast packet being delivered to another fabric chip.

5. A switch fabric comprising:
a first node chip;
a destination node chip; and
a first fabric chip comprising a plurality of port interfaces, wherein the first node chip is communicatively coupled to a first port interface of the plurality of port interfaces, wherein the first fabric chip is to receive a packet from the first node chip through the first port interface, wherein the first fabric chip comprises a port resolution module to determine a second port interface of the plurality of port interfaces that is to receive the packet for the packet to reach the destination node chip, and wherein the port resolution module is to determine the second port interface independently of software external to the port resolution module.

6. The switch fabric according to claim 5, wherein the first fabric chip further comprises:
a multicast data crossbar communicatively coupled to the plurality of port interfaces..

7. The switch fabric according to claim 5, further comprising:
a second fabric chip comprising a plurality of second fabric chip port interfaces, wherein the second fabric chip is communicatively coupled to a port interface of the first fabric chip through a second fabric chip port interface, wherein first fabric chip is to deliver the packet to the second fabric chip through the coupling, wherein the second fabric chip comprises a second fabric chip port resolution module to determine another second fabric chip port interface that is to receive the packet to reach the destination node.

8. The switch fabric according to claim 7, wherein the destination node chip is connected to a down-link port of at least one fabric chip port on any fabric chip in the switch fabric, and wherein the port resolution module is programmed with a prioritized list of port interfaces that identifies up-link ports for the packet to reach the destination node chip, and wherein the port interface through which the first fabric chip is communicatively coupled to the second fabric chip comprises a preferred up-link port.

9. The switch fabric according to claim 8, wherein the port resolution module is to communicate the packet through a next port interface in the prioritized list of port interfaces to the second fabric chip in response to the preferred up-link port being inactive.

10. The switch fabric according to claim 5, wherein the packet comprises a multicast packet, and wherein the first fabric chip is to replicate the multicast packet for communication to at least one of a second node chip connected to a down-link port of the first fabric chip and a second fabric chip, such that the first node chip need communicate a single multicast packet to reach multiple destination node chips.

11. The switch fabric according to claim 8, wherein the packet contains an identification of at least one destination node chip that is to receive the packet, and wherein first fabric chip is to remove the destination node chips from the identification to which the multicast packet has been delivered prior to delivering the multicast packet to the second fabric chip.

12. A method for implementing a switch fabric comprising a first fabric chip, having a plurality of port interfaces, said method comprising:
receiving a packet into a first port interface of the plurality of port interfaces, wherein the packet contains an identification of at least one destination node chip that is to receive the packet;
determining, in the first fabric chip, which port interface of the plurality of port interfaces is to receive the packet based upon the identification; and
communicating the packet to the determined port interface.

13. The method according to claim 12, wherein the first port interface is programmed with a list of correlations between the plurality of port interfaces and a plurality of destination nodes, and wherein determining, in the first fabric chip, which port interface of the plurality of port interfaces is to receive the packet further comprises determining which port interface is to receive the packet by comparing information contained in the data-list and the list of correlations.

14. The method according to claim 12, wherein the first port interface is programmed with a prioritized list of port interfaces that identifies up-link ports for the packets to reach destination node chips, said method further comprising:
determining, in the first fabric chip, that the communication of the packet to a second fabric chip over the determined port interface is unavailable;
selecting a next port interface in the prioritized list of port interfaces to receive the packet; and
automatically rerouting the communication of the packet through the next port interface for delivery of the packet to the destination node chip.

15. The method according to claim 12, wherein the packet comprises a multicast packet, said method further comprising:
delivering the multicast packet to a destination node chip;
removing, in the first port interface, the destination node chip from the data-list of the multicast packet to prune the data-list; and
delivering the multicast packet with the pruned data-list to a second fabric chip.
